(19) United States
(12) Patent Application Publication
(10) Pub. No.: US 2021/0379995 A1
(43) Pub. Date: Dec. 9, 2021

(54) DISPLAY CONTROL DEVICE, DISPLAY CONTROL SYSTEM, AND DISPLAY CONTROL METHOD

(71) Applicant: Mitsubishi Electric Corporation, Tokyo (JP)

(72) Inventor: Tomoki WATANABE, Tokyo (JP)

(73) Assignee: Mitsubishi Electric Corporation, Tokyo (JP)

(21) Appl. No.: 17/289,119

(22) PCT Filed: Jan. 28, 2019
(86) PCT No.: PCT/JP2019/002740

§ 371 Date: Apr. 27, 2021

(51) Int. Cl. B60K 35/00

(52) U.S. Cl. CPC B60K 35/00; B60K 2370/178; B60K 2370/1438; B60K 2370/1529; B60K 2370/741; B60K 2370/157; B60K 2370/739; B60K 2370/736; B60K 2370/52

(57) ABSTRACT

A display control device includes: a proximity determination unit for determining whether or not a driver's hand exists in a detection area created in front of a touch operation screen, on the basis of a detection result of an object existing in the detection area, the detection result being transmitted from a proximity detection device; an allocation changing unit for changing an operational allocation on the touch operation screen when the proximity determination unit has determined that the driver's hand exists in the detection area; and a display output unit for outputting allocation information to a HUD when the operational allocation on the touch operation screen is changed by the allocation changing unit, the allocation information being to cause the HUD to display a display allocation corresponding to the changed operational allocation.

### TECHNICAL FIELD

The present invention relates to a display control device, a display control system, and a display control method, by which an operational allocation on a touch operation screen can be changed.

### BACKGROUND ART

Heretofore, there have been provided display control devices by which an operation menu for an in-vehicle apparatus is displayed in a manner superimposed on a Head Up Display (hereinafter, referred to as a HUD) to thereby allow an operator to operate the in-vehicle apparatus while looking at a display content of that menu. Accordingly, the driver of a vehicle can make a selection from the operation menu displayed on the HUD, with a small movement of the sight line, while checking a view in front of the vehicle through the front windshield. A conventional display control device of this type is disclosed, for example, in Patent Literature 1.

### CITATION LIST

### Patent Literature

Patent Literature 1: Japanese Patent Application Laid-open No. 2017-114191

### SUMMARY OF INVENTION

### Technical Problem

The above conventional display control device is designed to allow a display content on the HUD to be changed in response to a gesture of the driver. Thus, the above conventional display control device has to properly detect the gesture of the driver, so that, in order to prevent erroneous detection, it is required that the sensor for detecting the gesture be highly precise.

This invention has been made to solve the problem as described above, and an object thereof is to provide a display control device which makes it possible to perform a touch operation onto a touch operation screen, without the necessity of a highly precise sensor.

### Solution to Problem

A display control device according to this invention includes: a proximity determination unit for determining whether or not a driver's hand exists in a detection area created in front of a touch operation screen, on the basis of a detection result of an object existing in the detection area, the detection result being transmitted from a proximity detection device; an allocation changing unit for changing an operational allocation on the touch operation screen when the proximity determination unit has determined that the driver's hand exists in the detection area; and a display output unit for outputting allocation information to a Head Up Display when the operational allocation on the touch operation screen is changed by the allocation changing unit, the allocation information being to cause the Head Up Display to display a display allocation corresponding to the changed operational allocation.

### Advantageous Effects of Invention

According to the invention, it is possible to perform a touch operation onto the touch operation screen, without the necessity of a highly precise sensor.

### BRIEF DESCRIPTION OF DRAWINGS

FIG. 1 is a block diagram showing a configuration of a display control system provided with a display control device according to Embodiment 1.

FIG. 2 is a block diagram showing a configuration of the display control device according to Embodiment 1.

FIG. 3: FIG. 3A is a diagram showing a hardware configuration example of the display control device according to Embodiment 1; FIG. 3B is a diagram showing another hardware configuration example of the display control device according to Embodiment 1.

FIG. 4 is a flowchart showing operational steps of the display control device according to Embodiment 1.

FIG. 5 is a diagram showing a touch operation screen, a navigation screen and a display screen of a HUD that are cooperatively subjected to display control by the display control device according to Embodiment 1.

FIG. 6 is a diagram showing how a display of a HUD is controlled by a display control device according to Embodiment 2.

FIG. 7 is a diagram showing how a display of a HUD is controlled by a display control device according to Embodiment 3.

### DESCRIPTION OF EMBODIMENTS

Hereinafter, for illustrating the invention in more detail, embodiments for carrying out the invention will be described with reference to the accompanying drawings.

### Embodiment 1

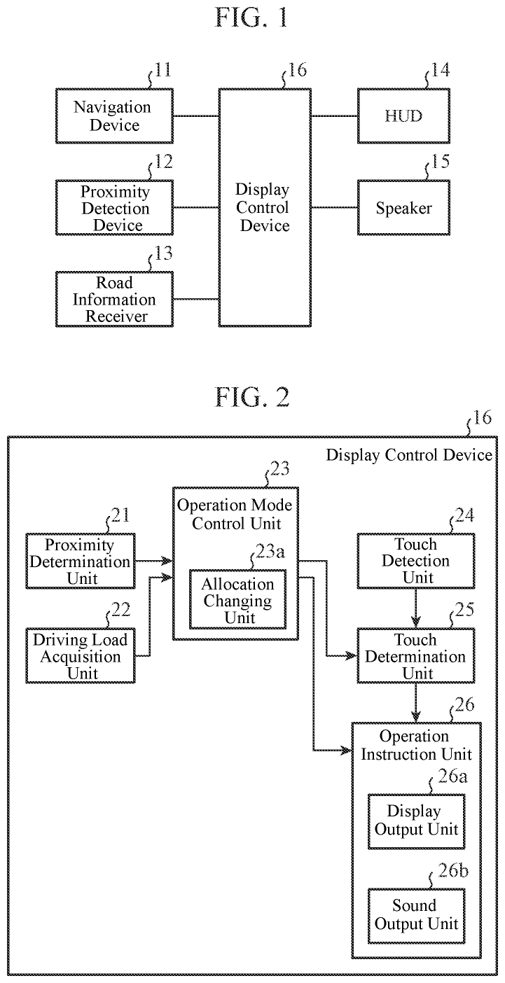

First of all, a configuration of a display control system according to Embodiment 1 will be described using FIG. 1. FIG. 1 is a block diagram showing the configuration of the display control system provided with a display control device according to Embodiment 1.

The display control system according to Embodiment 1 is a system installed in a vehicle. The display control system includes a navigation device 11, a proximity detection device 12, a road information receiver 13, a HUD 14, a speaker 15 and a display control device 16.

The navigation device 11 is provided in a vehicle-interior front section. The navigation device 11 includes a display and a touch panel. The front surface of the display and the rear surface of the touch panel are superposed on each other. The display is, for example, a liquid crystal panel.

Namely, the front surface of the display constitutes a navigation screen, and the front surface of the touch panel constitutes a touch operation screen. The touch operation screen serves to receive a touch operation by a vehicle occupant's hand. Further, the touch panel has a touch sensor. The touch sensor serves to detect a position at which the occupant touches the touch operation screen.

The proximity detection device 12 serves to detect an object which comes closer to the touch operation screen. For example, the proximity detection device 12 has a pair of a light emitting element and alight receiving element. Infrared light emitted from the light emitting element is reflected by the object and the thus-reflected infrared light is received by the light receiving element, so that the object is detected. The detection area of the proximity detection device 12 is created on the side toward the vehicle cabin, seen from the touch operation screen. Specifically, the detection area of the proximity detection device 12 has a specified length frontward from the touch operation screen, and is created in a spatial region positioned just above the touch operation screen. Namely, the detection area is created in a region through which an occupant's hand will pass when the occupant's hand is going to perform a touch operation onto the touch operation screen. Accordingly, for example, when a pair of the light emitting element and the light receiving element is provided at each of both lateral side portions of the touch operation screen, the proximity detection device 12 can distinguish between the case where an occupant's hand comes closer to the screen from the driver's seat side and the case where an occupant's hand comes closer to the screen from the passenger's seat side.

The road information receiver 13 serves to receive traffic information and information related to road conditions.

The HUD 14 is provided in front of the driver. The HUD 14 serves to display vehicle information and road guidance information related to the vehicle during traveling. Further, when the driver's hand is detected by the proximity detection device 12, the HUD 14 changes its display allocation to a display screen related to an audio operation mode and a display screen related to an air-conditioner operation mode, and performs display.

The speaker 15 outputs a sound/voice in the audio operation mode, a warning sound for the driver, and the like.

The display control device 16 serves to control what is displayed by the HUD 14 and what is outputted by the speaker 15, on the basis of various pieces of information obtained from the navigation device 11, the proximity detection device 12 and the road information receiver 13. Further, the display control device 16 serves to change an operational allocation on the touch operation screen and a display allocation of the HUD 14.

Next, a configuration of the display control device according to Embodiment 1 will be described using FIG. 2. FIG. 2 is a block diagram showing the configuration of the display control device according to Embodiment 1.

The display control device 16 includes a proximity determination unit 21, a driving load acquisition unit 22, an operation mode control unit 23, a touch detection unit 24, a touch determination unit 25 and an operation instruction unit 26.

On the basis of an object detection result transmitted from the proximity detection device 12, the proximity determination unit 21 determines whether or not a driver's hand exists in the detection area, and then outputs the determination result to the operation mode control unit 23.

The driving load acquisition unit 22 acquires, as driving load information related to a driver's load for driving, the traffic information and the information related to road conditions transmitted from the road information receiver 13, and then outputs the thus-acquired driving load information to the operation mode control unit 23. Further, the driving load acquisition unit 22 has a function of determining whether the acquired driving load is high or not. Note that a state in which the driving load is high is, for example, a state in which the driver has to immediately perform a steering wheel operation, a pedal operation, a shift operation or the like.

On the basis of the determination result transmitted from the proximity determination unit 21, the operation mode control unit 23 selects a navigation operation mode or both the audio operation mode and the air-conditioner operation mode, and then outputs the selection result to the touch determination unit 25 and the operation instruction unit 26. Further, the operation mode control unit 23 outputs the driving load information transmitted from the driving load acquisition unit 22, to the operation instruction unit 26.

The operation mode control unit 23 has an allocation changing unit 23a. When the proximity determination unit 21 has determined that the driver's hand exists in the detection area, the allocation changing unit 23a changes an operational allocation on the touch operation screen, to an operational allocation for the audio operation mode and an operational allocation for the air-conditioner operation mode. Further, when having received from the proximity determination unit 21, a determination result indicating that the driver's hand and a hand of the passenger-seat occupant both exist, the allocation changing unit 23a prioritizes the operational allocation which the driver's hand is going to use to perform the touch operation.

It is noted that an “operational allocation” on the touch operation screen, means a touch operation area created on the touch operation screen. For example, the operational allocation for the audio operation mode is a touch operation area created on the touch operation screen for operating an audio. Further, the operational allocation for the air-conditioner operation mode is a touch operation area created on the touch operation screen for operating an air conditioner.

When an occupant's hand has touched the touch operation screen, the touch detection unit 24 acquires from the touch sensor, touch position information related to a touch position in the touch operation screen, and then outputs the touch position information to the touch determination unit 25.

On the basis of the selection result transmitted from the operation mode control unit 23 and the touch position information transmitted from the touch detection unit 24, the touch determination unit 25 determines the type of the operational allocation selected by the occupant's hand touching the touch operation screen.

On the basis of the selection result transmitted from the operation mode control unit 23 and the determination result transmitted from the touch determination unit 25, the operation instruction unit 26 gives an operational instruction to at least one of the navigation device 11, the HUD 14 and the speaker 15. The operation instruction unit 26 has a display output unit 26a and a sound output unit 26b.

The display output unit 26a serves to output allocation information to the HUD 14 when the operational allocation on the touch operation screen is changed by the allocation changing unit 23a to the operational allocation for the audio operation mode and the operational allocation for the air-conditioner operation mode, the allocation information causing the HUD 14 to display a display allocation for the audio operation mode and a display allocation for the air-conditioner operation mode that are corresponding to the two operational allocations. Further, the display output unit 26a serves to output to the HUD 14, warning information for causing the HUD 14 to display a warning to the driver.

The sound output unit 26b serves to output to the speaker 15, warning information for generating a warning to the driver from the speaker 15.

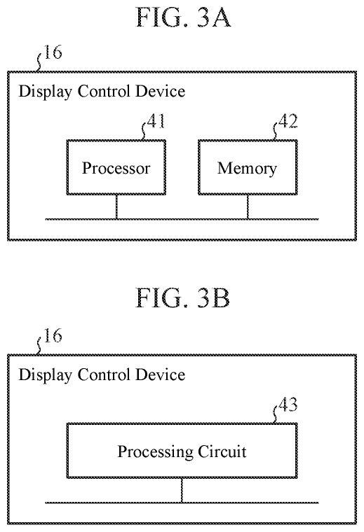

Next, hardware configurations of the display control device according to Embodiment 1 will be described using FIG. 3. FIG. 3A is a diagram showing a hardware configuration example of the display control device according to Embodiment 1. FIG. 3B is a diagram showing another hardware configuration example of the display control device according to Embodiment 1.

As shown in FIG. 3A, the display control device 16 is configured with a computer, and the computer has a processor 41 and a memory 42. In the memory 42, there is stored a program for causing the computer to function as the proximity determination unit 21, the driving load acquisition unit 22, the operation mode control unit 23, the touch detection unit 24, the touch determination unit 25 and the operation instruction unit 26. The processor 41 reads out and executes the program stored in the memory 42, and thereby the functions of the proximity determination unit 21, the driving load acquisition unit 22, the operation mode control unit 23, the touch detection unit 24, the touch determination unit 25 and the operation instruction unit 26 are implemented.

Instead, as shown in FIG. 3B, the display control device 16 may have a processing circuit 43. In this case, the functions of the proximity determination unit 21, the driving load acquisition unit 22, the operation mode control unit 23, the touch detection unit 24, the touch determination unit 25 and the operation instruction unit 26 may be implemented by the processing circuit 43.

Instead, the display control device 16 may have the processor 41, the memory 42 and the processing circuit (not illustrated). In this case, it is allowed that a part of the functions of the proximity determination unit 21, the driving load acquisition unit 22, the operation mode control unit 23, the touch detection unit 24, the touch determination unit 25 and the operation instruction unit 26 is implemented by the processor 41 and the memory 42, while the other part of the functions is implemented by the processing circuit 43.

The processor 41 uses, for example, at least one of a Central Processing Unit (CPU), a Graphics Processing Unit (GPU), a microprocessor, a microcontroller and a Digital Signal Processor (DSP).

The memory 42 uses, for example, at least either a semiconductor memory or a magnetic disk. More specifically, the memory 42 uses at least one of a Random Access Memory (RAM), a Read Only Memory (ROM), a flash memory, an Erasable Programmable Read Only Memory (EPROM), an Electrically Erasable Programmable Read Only Memory (EEPROM), a Solid State Drive (SSD) and a hard Disk Drive (HDD).

The processing circuit 43 uses, for example, at least one of an Application Specific Integrated Circuit (ASIC), a Programmable Logic Device (PLD), a Field-Programmable Gate Array (FPGA), a System-on-a-Chip (SoC) and a system Large-Scale Integration (LSI).

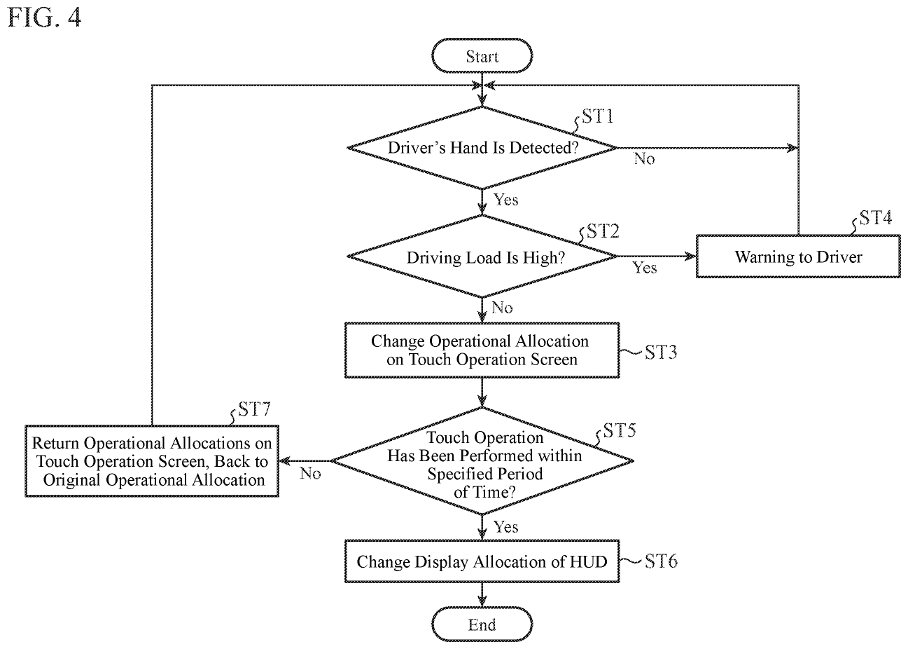

Next, operations of the display control device according to Embodiment 1 will be described using FIG. 4. FIG. 4 is a flowchart showing operational steps of the display control device according to Embodiment 1.

In Step ST1, the proximity determination unit 21 determines whether or not the driver's hand exists in the detection area. If the proximity determination unit 21 determines in this Step that the driver's hand exists in the detection area, the operation of the display control device 16 moves to Step ST2. In contrast, if the proximity determination unit 21 determines that no driver's hand exists in the detection area, the operation of the display control device 16 is to repeat Step ST1.

In Step ST2, the driving load acquisition unit 22 determines whether the acquired driving load is high or not. If the driving load acquisition unit 22 determines in this Step that the driving load is not high, the operation of the display control device 16 moves to Step ST3. In contrast, if the driving load acquisition unit 22 determines that the driving load is high, the operation of the display control device 16 moves to Step ST4.

In Step ST3, the allocation changing unit 23a changes the operational allocation on the touch operation screen, to the operational allocation for the audio operation mode and the operational allocation for the air-conditioner operation mode.

On the other hand, in Step ST4, the display output unit 26a outputs to the HUD 14, warning information for causing the HUD 14 to display a warning to the driver. At that time, the sound output unit 26b may output to the speaker 15, warning information for generating a warning to the driver from the speaker 15.

In Step ST5, the touch detection unit 24 determines whether or not the driver's hand has touched the touch operation screen within a specified period of time from the time the operational allocation for the audio operation mode and the operational allocation for the air-conditioner operation mode have been created on the touch operation screen. If the touch detection unit 24 determines in this Step that the driver's hand has touched the touch operation screen, the operation of the display control device 16 moves to Step ST6. In contrast, if the touch detection unit 24 determines that the driver's hand has not touched the touch operation screen, the operation of the display control device 16 moves to Step ST7.

In Step ST6, the display output unit 26a outputs to the HUD 14, allocation information for causing the HUD 14 to display two display allocations corresponding to the two operational allocations. Namely, the display allocation of the HUD 14 is changed to the display allocation corresponding to the operational allocation for the audio operation mode and the display allocation corresponding to the operational allocation for the air-conditioner operation mode.

On the other hand, in Step ST7, the allocation changing unit 23a returns the operational allocations on the touch operation screen, namely, the operational allocation for the audio operation mode and the operational allocation for the air-conditioner operation mode, back to the original operational allocation. Then, the operation of the display control device 16 returns to Step ST1.

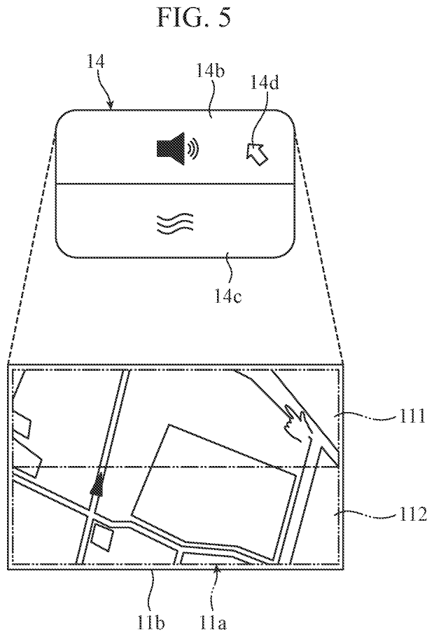

Next, a correspondence relationship between a set of the navigation screen and the touch operation screen and the display screen of the HUD in the display control system according to Embodiment 1, will be described using FIG. 5. FIG. 5 is a diagram showing the touch operation screen, the navigation screen and the display screen of the HUD that are cooperatively subjected to display control by the display control device according to Embodiment 1. Note that FIG. 5 is given assuming that the driver's hand exists in the detection area.

When the driver's hand exists in the detection area, the allocation changing unit 23a changes the upper half section of a touch operation screen 11a and the lower half section of the touch operation screen 11a, to an operational allocation 111 for the audio operation mode and an operational allocation 112 for the air-conditioner operation mode, respectively, without changing the display content on a navigation screen 11b of the navigation device 11.

In response to this, the display output unit 26a causes a display allocation 14b for the audio operation mode and a display allocation 14c for the air-conditioner operation mode, to be displayed in the upper half section of the HUD 14 and the lower half section of the HUD 14, respectively.

Further, when the driver's hand performs a touch operation using the operational allocation 111, 112, the display output unit 26a outputs to the HUD 14, linkage information for causing the HUD 14 to display an indication linked with the movement of the driver's hand. Accordingly, the position of an icon 14d displayed on the HUD 14 corresponds to the position of the driver's hand performing the touch operation on the touch operation screen 11a. The movement of the icon 14d is linked with the movement of the driver's hand performing the touch operation on the touch operation screen 11a.

Thus, the display control device 16, even when it causes switching to the audio operation mode and the air-conditioner operation mode, does not change the display content on the navigation screen 11b, so that the driver can continue, without change, seeing road guidance information displayed on the navigation screen 11b. Further, the display control device 16, even when it causes switching to the audio operation mode and the air-conditioner operation mode, does not change the display content on the navigation screen 11b, so that, when a passenger-seat occupant is watching something by using the navigation screen 11b, the display control device 16 never disturbs his/her watching. Note that the display control device 16 may change the display content on the navigation screen 11b at the time of switching to the audio operation mode and the air-conditioner operation mode.

The display control device 16 can move the icon 14d displayed on the HUD 14 in such a manner that it is linked with the movement of the driver's hand performing the touch operation on the touch operation screen 11a. Thus, the driver can check where his/her hand is located on the touch operation screen 11a by looking at the icon 14d displayed on the HUD 14.

The detection area for detecting the driver's hand has a specified length frontward from the touch operation screen 11a, and is created just above the touch operation screen 11a. Thus, the display control device 16 does not erroneously detect a movement of the driver's hand caused by a steering operation, a shift operation or the like that is not related to an audio operation and an air-conditioner operation.

Note that, the detection area is not necessarily required to be created just above the touch operation screen 11a.

As described above, the display control device 16 according to Embodiment 1 includes: the proximity determination unit 21 for determining whether or not the driver's hand exists in the detection area created in front of the touch operation screen 11a, on the basis of a detection result of an object existing in the detection area, the detection result being transmitted from the proximity detection device 12; the allocation changing unit 23a for changing the operational allocation on the touch operation screen 11a when the proximity determination unit 21 has determined that the driver's hand exists in the detection area; and the display output unit 26a for outputting allocation information to the HUD 14 when the operational allocation on the touch operation screen 11a is changed by the allocation changing unit 23a, the allocation information being to cause the HUD 14 to display the display allocations 14b, 14c corresponding to the changed operational allocations 111, 112. Accordingly, the display control device 16 can make it possible to perform a touch operation onto the touch operation screen 11a, without the necessity of a highly precise sensor. Since the proximity detection device 12 serves to detect presence/absence of an object within a preset detection area, the proximity detection device 12 is a less precise detection device in comparison with, for example, a sensor capable of detecting a gesture or the like, of the driver.

The allocation changing unit 23a creates the changed operational allocations 111, 112 on the touch operation screen, in a form of two divided allocations. Accordingly, the display control device 16 can broadly define the operational allocation 111 for the audio operation mode and the operational allocation 112 for the air-conditioner operation mode. This makes it possible to improve ease of touch operation onto the touch operation screen 11a.

The display output unit 26a outputs to the HUD 14, the allocation information for causing the HUD 14 to display the two divided display allocations 14b, 14c. Accordingly, the display allocation 14b for the audio operation mode and the display allocation 14c for the air-conditioner operation mode are displayed in two upper and lower rows, so that the display control device 16 can save the effort of the driver to seek the frequently-used audio operation mode or air-conditioner operation mode, and can reduce the number of his/her touch operations onto the touch operation screen 11a.

According to the display control device 16, the detection area of the proximity detection device 12 is created just above the touch operation screen 11a. Accordingly, the display control device 16 can prevent erroneous detection due to the movement of the driver's hand caused by the steering operation, the shift operation or the like that is not related to the audio operation and the air-conditioner operation.

The allocation changing unit 23a makes it possible to perform a touch operation using the operational allocation 111 for the audio operation mode or the operational allocation 112 for the air-conditioner operation mode on the touch operation screen 11a, without changing the display content on the navigation screen 11b. Thus, even when the driver performs a touch operation onto the touch operation screen 11a, the display control device 16 never disturbs watching the navigation screen 11b.

When having received from the proximity determination unit 21, a determination result indicating that the driver's hand and a hand of the passenger-seat occupant both exist, the allocation changing unit 23a prioritizes the operational allocation which the driver's hand is going to use to perform a touch operation. Accordingly, even if the passenger's seat occupant is going to perform a touch operation without being aware of the change of the operation mode, the display control device 16 can prioritize the change of the operation mode caused by the driver.

For example, when, in a state where the passenger's seat occupant is operating a chapter button or the like on the touch operation screen 11a, the driver's hand touches the touch operation screen 11a, the display control device 16 changes the operation mode without changing the display content on the navigation screen 11b. Thus, although the button is being displayed on the navigation screen 11b, the button is no longer allocated on the touch operation screen 11a.

When the driver has to perform a steering wheel operation and it is determined by the proximity determination unit 21 that the driver's hand exists in the detection area, the display output unit 26a outputs to the HUD 14, warning information for causing the HUD 14 to display a warning to the driver. Accordingly, the display control device 16 can cause the driver to concentrate on the steering wheel operation.

When the driver's hand performs a touch operation using the operational allocation 111, 112 on the touch operation screen 11a changed by the allocation changing unit 23a, the display output unit 26a outputs to the HUD 14, linkage information for causing the HUD 14 to display an indication linked with the movement of the driver's hand. Accordingly, the display control device 16 can cause the driver to easily check, by looking at the icon 14d displayed on the HUD 14, where his/her hand is located on the touch operation screen 11a.

The display control system according to Embodiment 1 includes the display control device 16, the navigation device 11 provided with the touch panel having the touch operation screen 11a, and the HUD 14 to display the display allocations 14b, 14c corresponding to the operational allocations 111, 112 on the touch operation screen 11a. Accordingly, the display control system can make it possible to perform a touch operation onto the touch operation screen 11a, without the necessity of a highly precise sensor.

A display control method according to Embodiment 1 includes: determining, using the proximity determination unit 21, whether or not the driver's hand exists in the detection area created in front of the touch operation screen 11a, on the basis of a detection result of an object existing in the detection area, the detection result being transmitted from the proximity detection device 12; changing, using the allocation changing unit 23a, the operational allocation on the touch operation screen 11a when the proximity determination unit 21 has determined that the driver's hand exists in the detection area; and outputting, using the display output unit 26a, allocation information to the HUD 14 when the operational allocation on the touch operation screen 11a is changed by the allocation changing unit 23a, the allocation information being to cause the HUD 14 to display the display allocations 14b, 14c corresponding to the changed operational allocations 111, 112. Accordingly, the display control method can make it possible to perform a touch operation onto the touch operation screen 11a, without the necessity of a highly precise sensor.

### Embodiment 2

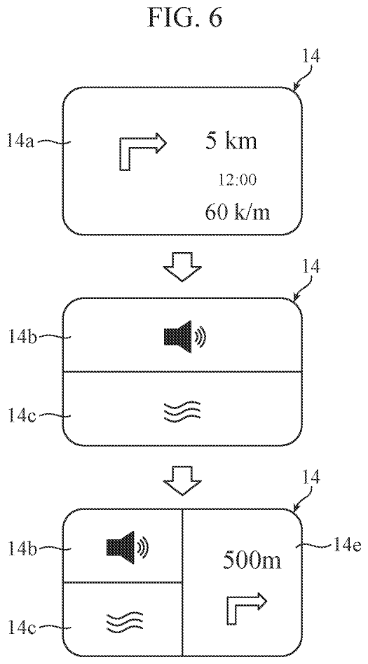

A display control device according to Embodiment 2 will be described using FIG. 6. FIG. 6 is a diagram showing how a display of a HUD is controlled by the display control device according to Embodiment 2. Note that FIG. 6 is given assuming that there is a time interval between the time the driver's hand comes in the detection area and the time the driver becomes required to perform a steering wheel operation.

When the driver's hand exists in the detection area, the display output unit 26a switches a current display allocation 14a to the two divided upper and lower display allocations 14b, 14c. Then, when there is a specified period of time or more before the next steering wheel operation by the driver, the display output unit 26a outputs to the HUD 14, additional display information for causing the HUD 14 to additionally display a road-information display allocation 14e that is matched with the next steering wheel operation by the driver. Accordingly, the HUD 14 additionally displays the road-information display allocation 14e, in addition to displaying the display allocations 14b, 14c. The road-information display allocation 14e is an area for displaying road information that is matched with the next steering wheel operation by the driver.

As described above, in the display control device 16 according to Embodiment 2, the display output unit 26a outputs to the HUD 14, the additional display information for causing the HUD 14 to additionally display the road-information display allocation 14e that is matched with the next steering wheel operation by the driver. Accordingly, when the driver, who feels that there is time before the next steering wheel operation, is performing an audio operation or an air-conditioner operation, the display control device 16 can notify the driver that he/she will soon have to perform a steering wheel operation.

### Embodiment 3

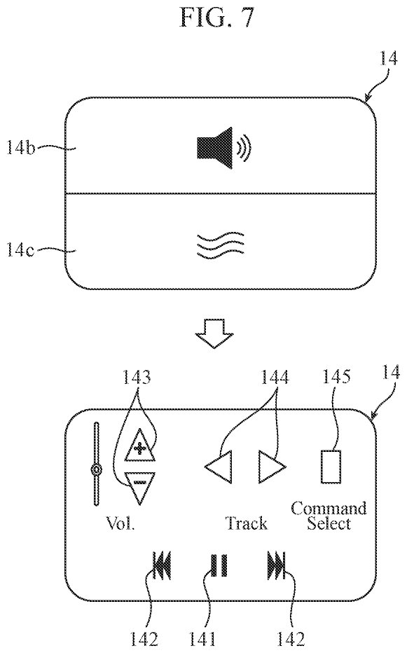

A display control device according to Embodiment 3 will be described using FIG. 7. FIG. 7 is a diagram showing how a display of a HUD is controlled by the display control device according to Embodiment 3. Note that FIG. 7 is given assuming that the driver's hand comes in the detection area, so that the operation mode is switched to the audio operation mode and the air-conditioner operation mode.

When, for example, a touch operation is performed on the operational allocation 111, one of the operational allocations 111, 112 on the touch operation screen 11a, the display output unit 26a causes the HUD 14 to switch from displaying the display allocations 14b, 14c to displaying multiple command operation buttons 141 to 144 related to the audio operation mode.

The HUD 14 not only collectively displays the command operation button 141 for reproducing or stopping music, the command operation button 142 for fast-forward or return operation for music, the command operation button 143 for adjusting the volume of sound and the command operation button 144 for selecting a song, for example, but also concurrently displays a command switch button 145.

The command switch button 145 is used to cause switching from collectively displaying the above-described multiple command operation buttons 141 to 144 related to the audio operation mode, to collectively displaying multiple command operation buttons related to the navigation operation mode or to collectively displaying multiple command operation buttons related to the air-conditioner operation mode. Further, the command switch button 145 is always displayed with the collectively displayed command operation buttons in every operation mode.

Namely, the display output unit 26a outputs to the HUD 14, button display information for causing the HUD 14 to display the command switch button 145 which makes it possible for the HUD to perform switching to displaying command operation buttons corresponding to the operational allocation 112 other than the operational allocation 111. Accordingly, by one touch operation onto the touch operation screen 11a, the display output unit 26a can cause switching from collectively displaying the multiple command operation buttons 141 to 144 related to the audio operation mode, to collectively displaying multiple command operation buttons related to the navigation operation mode or to collectively displaying multiple command operation buttons related to the air-conditioner operation mode.

As described above, in the display control device 16 according to Embodiment 3, the display output unit 26a outputs to the HUD 14, button display information for causing the HUD 14 to display the command switch button 145 which makes it possible to switch to displaying the command operation buttons corresponding to the operational allocation 112 other than the operational allocation 111. Thus, according to the display control device 16, it is possible to adequately set the number of command operation buttons to be displayed at once. As a result, according to the display control device 16, when the driver is going to select a command operation button to be operated from among a wide variety of command operation buttons, it is possible to shorten the time until the driver finds the command operation button to be operated. Thus, according to the display control device 16, it is possible to shorten the time for the driver to carefully watch the HUD 14.

It should be noted that unlimited combination of the embodiments, modification of any component in the embodiments, or omission of any component in the embodiments may be made in the present invention without departing from the scope of the invention.

### INDUSTRIAL APPLICABILITY

According to the display control device, the display control system and the display control method of this invention, when the driver's hand exists in the detection area, it is possible to change the operational allocation on the touch operation screen and to cause the Head Up Display to display the display allocation corresponding to the changed operational allocation. Thus, they are suited for use as a display control device, a display control system and a display control method which allow the operational allocation on the touch operation screen to be changed.

### REFERENCE SIGNS LIST

11: navigation device, 11a: touch operation screen, 111, 112: operational allocation, 11b: navigation screen, 12: proximity detection device, 13: road information receiver, 14: HUD, 14a to 14c: display allocations, 14d: icon, 14e: road-information display allocation, 141 to 144: command operation buttons, 145: command switch button, 15: speaker, 16: display control device, 21: proximity determination unit, 22: driving load acquisition unit, 23: operation mode control unit, 23a: allocation changing unit, 24: touch detection unit, 25: touch determination unit, 26: operation instruction unit, 26a: display output unit, 26b: sound output unit, 41: processor, 42: memory, 43: processing circuit.

1. A display control device comprising:
processing circuitry
to determine whether or not a driver's hand exists in a detection area created in front of a touch operation screen, on a basis of a transmitted detection result of an object existing in the detection area;
to change an operational allocation on the touch operation screen when it is determined that the driver's hand exists in the detection area; and
to output allocation information to a Head Up Display when the operational allocation on the touch operation screen is changed, the allocation information being to cause the Head Up Display to display a display allocation corresponding to the changed operational allocation.

2. The display control device of claim 1, wherein the processing circuitry creates the changed operational allocation on the touch operation screen, in a form of two divided allocations.

3. The display control device of claim 1, wherein the processing circuitry outputs the allocation information to the Head Up Display, the allocation information being to cause the Head Up Display to display the display allocation including two divided allocations.

4. The display control device of claim 1, wherein the detection area is created just above the touch operation screen.

5. The display control device of claim 1, wherein the processing circuitry makes it possible to perform a touch operation using the changed operational allocation on the touch operation screen, without changing a display content on a navigation screen.

6. The display control device of claim 5, wherein, when having received a determination result indicating that the driver's hand and a hand of a passenger-seat occupant both exist, the processing circuitry prioritizes the operational allocation which the driver's hand is going to use to perform a touch operation.

7. The display control device of claim 1, wherein, when the driver has to perform a steering wheel operation and it is determined that the driver's hand exists in the detection area, the processing circuitry outputs to the Head Up Display, warning information for causing the Head Up Display to display a warning to the driver.

8. The display control device of claim 1, wherein, when the driver's hand performs a touch operation using the changed operational allocation on the touch operation screen, the processing circuitry outputs to the Head Up Display, linkage information for causing the Head Up Display to display an indication linked with a movement of the driver's hand.

9. The display control device of claim 1, wherein the processing circuitry outputs to the Head Up Display, additional display information for causing the Head Up Display to additionally display a road-information display allocation that is matched with a next steering wheel operation by the driver.

10. The display control device of claim 1, wherein the processing circuitry outputs to the Head Up Display, button display information for causing the Head Up Display to display a command switch button, the command switch button making it possible to switch to displaying one or more command operation buttons corresponding to another operational allocation.

11. A display control system comprising:
the display control device of claim 1;
a navigation device provided with a touch panel having the touch operation screen; and
the Head Up Display to display the display allocation corresponding to the operational allocation on the touch operation screen.

12. A display control method comprising:
determining whether or not a driver's hand exists in a detection area created in front of a touch operation screen, on a basis of a transmitted detection result of an object existing in the detection area;
changing an operational allocation on the touch operation screen when it is determined that the driver's hand exists in the detection area; and
outputting allocation information to a Head Up Display when the operational allocation on the touch operation screen is changed, the allocation information being to cause the Head Up Display to display a display allocation corresponding to the changed operational allocation.
